(19) United States
(12) Patent Application Publication
(10) Pub. No.: US 2003/0145314 A1
(43) Pub. Date: Jul. 31, 2003

(54) Method of efficient dynamic data cache prefetch insertion

(76) Inventors: Khoa Nguyen, San Jose, CA (US); Wei Hsu, Vadnais Heights, MN (US); Hui-May Chang, Saratoga, CA (US)

Correspondence Address: CAMPBELL STEPHENSON ASCOLESE, LLP, 4807 SPICEWOOD SPRINGS RD., BLDG. 4, SUITE 201, AUSTIN, TX, 78759, US

(21) Appl. No.: 10/061,384

(22) Filed: Jan. 31, 2002

(51) Int. Cl. G06F 9/45; G06F 12/00

(52) U.S. Cl. 717/158; 711/118

(57) ABSTRACT

A system and method for dynamically inserting a data cache prefetch instruction into a program executable to optimize the program being executed. The method, and system thereof, monitors the execution of the program, samples on the cache miss events, identifies the time-consuming execution paths, and optimizes the program during runtime by inserting a prefetch instruction into a new optimized code to hide cache miss latency.

### BACKGROUND OF THE INVENTION

1. Field of the Invention

The present invention relates to computer systems. More specifically, the present invention relates to a method and a system for optimization of a program being executed.

2. Description of Related Art

Processor speeds have been increasing at a much faster rate than memory access speeds during the past several generations of products. As a result, it is common for programs being executed on present day processors to spend almost half of their run time stalled on memory requests. The expanding gap between the processor and the memory performance has increased the focus on hiding and/or reducing the latency of main memory access. For example, an increasing amount of cache memory is being utilized to reduce the latency of memory access.

A cache is typically a small, higher speed, higher performance memory system which stores the most recently used instructions or data from a larger but slower memory system. Programs frequently use a subset of instructions or data repeatedly. As a result, the cache is a cost effective method of enhancing the memory system in a ‘statistical’ method, without having to resort to the expense of making the entire memory system faster.

For many programs that are being executed by a processor, the occurrence of long latency events such as data cache misses and/or branch mispredictions have typically resulted in a loss of program performance. Inserting cache prefetch instructions is an effective way to overlap cache miss latency with program execution. In data cache prefetching, instructions that prefetch the cache line for the data are inserted sufficiently prior to the actual reference of the data, thereby hiding the cache miss latency.

Static prefetch insertion performed at compile time has generally not been very successful, partly because the cache miss behavior may vary at runtime. Typically, the compiler does not know whether a memory load will hit or miss, in the data cache. Thus, data cache prefetch may not be effectively inserted during compile time. For example, a compiler inserting prefetches into a loop that has no or low cache misses during runtime may incur significant slow down due to overhead associated with each prefetch. Therefore, static cache prefetch has been usually guided by programmer directives. Another alternative is to use program training profile to identify loops with frequent data cache misses, and feedback the information to the compiler. However, since a compiled program will be executed in a variety of computing environment and under different usage patterns, using cache miss profile from training runs to guide prefetch has not been established as a reliable optimization method.

Latency of memory access may also be reduced by utilizing a hardware cache prefetch engine. For example, the processor could be enhanced with a data cache prefetch engine. A simple stride-based prefetch engine may, for example, track cache misses with regular strides and initiate prefetch with stride. As another method, the prefetch engine may prefetch data automatically. This method typically handles only regular memory references with strides, but there may be no provision for indirect reference patterns. A Markov Predictor based engine may be used to remember reference correlation, to track cache miss patterns and to initiate cache prefetches. However, this approach typically utilizes a large amount of memory to remember the correlation. The Markov Predictor based engine may also take up much of the chip area making it impractical.

It may be desirable to dynamically optimize program performance. As described herein, dynamic generally refers to actions that take place at the moment they are needed, e.g., during runtime, rather than in advance, e.g., during compile time.

### SUMMARY OF THE INVENTION

In accordance with the present invention and in one embodiment, a method for dynamically inserting a data cache prefetch instruction into a program executable to optimize the program being executed is described.

In one embodiment, the method, and system thereof, monitors the execution of the program, samples on the cache miss events, identifies the time-consuming execution paths, and optimizes the program during runtime by inserting a prefetch instruction into a new optimized code to hide cache miss latency.

In another embodiment, a method and system thereof for optimizing instructions, the instructions being included in a program being executed, includes collecting information that describes occurrences of a plurality of cache misses caused by at least one instruction. The method identifies a performance degrading instruction that contributes to the highest number of occurrences of cache misses. The method optimizes the program to provide an optimized sequence of instructions by including at least one prefetch instruction in the optimized sequence of instructions. The program being executed is modified to include the optimized sequence.

In another embodiment, a method of optimizing a program having a plurality of execution paths includes collecting information that describes occurrences of a plurality of cache miss events during a runtime mode of the program. The method includes identifying a performance degrading execution path in the program. The performance degrading execution path is modified to define an optimized execution path. The optimized execution path includes at least one prefetch instruction. The optimized execution path having the at least one prefetch instruction is stored in memory. The performance degrading execution path in the program is redirected to include the optimized execution path.

In yet another embodiment, a method of optimizing a program includes receiving information that describes a dependency graph for an instruction causing frequent cache misses. The method determines whether a cyclic dependency pattern exists in the graph. If it is determined that the cyclic dependency pattern exists then, stride information that may be derived from the cyclic dependency pattern is computed. At least one prefetch instruction derived from the stride information is inserted in the program prior to the instruction causing the frequent cache misses. The prefetch instruction is reused in the program for reducing subsequent cache misses. The steps of receiving, determining, computing, and inserting are performed during runtime of the program.

In one embodiment, a computer-readable medium includes a computer program that is accessible from the medium. The computer program includes instructions for collecting information that describes occurrences of a plurality of cache misses caused by at least one instruction. The instructions identify a performance degrading instruction that causes greatest performance penalty from cache misses. The instructions optimize the program to provide an optimized sequence of instructions such that the optimized sequence of instructions includes at least one prefetch instruction. The instructions modify the program being executed to include the optimized sequence.

### BRIEF DESCRIPTION OF THE DRAWINGS

The present invention may be better understood, and its numerous objects, features, and advantages made apparent to those skilled in the art by referencing the accompanying drawings. The use of the same reference symbols in different drawings indicates similar or identical items.

FIG. 1 is a block diagram illustrating a dynamic optimizer in accordance with the present invention;

FIG. 2 illustrates a flowchart of a method for optimizing a program being executed;

FIG. 3 illustrates a flowchart of a method for optimizing a program being executed;

FIG. 4 illustrates a flowchart of a method for optimizing a program being executed;

FIGS. 5A-5D illustrate two examples of program code being optimized at runtime in accordance with the present invention

FIG. 6 is a block diagram illustrating a network environment in which a system in accordance with the present invention may be practiced;

FIG. 7 depicts a block diagram of a computer system suitable for implementing the present invention; and

FIG. 8 is a block diagram depicting a network having the computer system of FIG. 7.

### DETAILED DESCRIPTION

For a thorough understanding of the subject invention, including the best mode contemplated by the inventors for practicing the invention, reference may be had to the following Detailed Description, including the appended claims, in connection with the above-described Drawings. The following Detailed Description of the invention is intended to be illustrative only and not limiting.

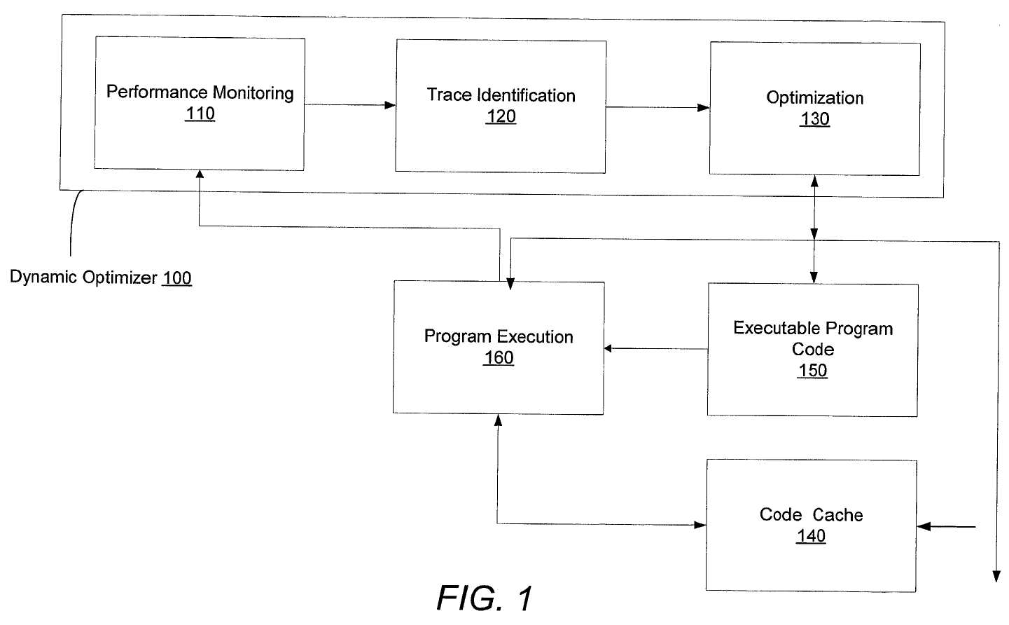

Referring to FIG. 1, in one embodiment, a dynamic or runtime optimizer 100 includes three phases. The dynamic optimizer 100 may be used to optimize a program dynamically, e.g., during runtime rather than in advance.

A program performance monitoring 110 phase is initiated when program execution 160 is initiated. Program performance may be difficult to characterize since the programs typically do not perform uniformly well or uniformly poorly. Rather, most programs exhibit stretches of good performance punctuated by performance degrading events. The overall observed performance of a given program depends on the frequency of these events and their relationship to one another and to the rest of the program.

Program performance may be measured by a variety of benchmarks, for example by measuring the throughput of executed program instructions. The presence of a long latency instruction typically impedes execution and degrades program performance. A performance degrading event may be caused by or may occur as a result of an execution of a performance degrading instruction. Branch mispredictions, and instruction and/or data cache misses account for the majority of the performance degrading events.

Data cache misses may be detected by using hardware and/or software techniques. For example, many modern processors include a hardware performance monitoring functionality to assist identifying performance degrading instructions, e.g., instructions with frequent data cache misses. On some processors, the performance monitor may be programmed to deliver an interrupt after a number of data cache miss events have occurred. The address of the latest cache miss instruction and/or the instruction causing the most cache misses may also be recorded.

Some other processors may support an instruction-centric, in addition to an event-centric, type of monitoring. Instructions may be randomly sampled at instruction fetch stage, and detailed execution information for the selected instruction, such as cache miss events, may be recorded. Instructions that frequently missed the data cache may obtain a higher probability to get sampled and reported.

Information describing the program execution 160, particularly information describing the performance degrading events, is collected during performance monitoring 110 phase. Program hot spots, such as a particular instruction contributing to the most latency are identified using statistical sampling. The program may include following one or more execution paths from program initiation to program termination. The information may include collecting statistical information for each of the executed paths.

In one embodiment, once sufficient samples are collected, the program execution 160 may be suspended so that the dynamic optimizer 100 can start trace selection 120 and optimization 130 phases. A trace, as referred to herein, may typically include a sequence of program code blocks that have a single entry with multiple exits. Obtaining a trace of the program, as referred to herein, may typically include capturing and/or recording a sequence of instructions being executed.

In another embodiment, trace selection 120 phase and optimization phase 130 may be initiated without suspending the program execution 160 phase. For example, the program may include code to dynamically modify a portion of the program code while executing a different, unmodified portion of the program code.

In the trace selection 120 phase, the most frequent execution paths are selected and new traces are formed for the selected paths. Trace selection is based on the branch information (such as branch trace or branch history information) gathered during performance monitoring 110 phase. The trace information collected typically includes a sequence of instructions preceding the performance degrading instruction.

During the optimization 130 phase, the formed new traces are optimized. On completion of the code optimization the optimized traces may be stored in a code cache 140 as optimized code. The locations in the executable program code 150 leading to a selected execution path are patched with a branch jumping to the newly generated optimized code in the code cache 140.

In one embodiment, the patch to the optimized new code may be performed dynamically, e.g., while the program is executing. In another embodiment, it may be performed while the program is suspended. In the embodiment using program suspension to install the patch, the program is placed in execution mode from the suspend mode after installation of the patch. Subsequent execution of the selected execution path is redirected to the new optimized trace and advantageously executes the optimized code. As described earlier, since a few instructions typically contribute to a majority of the data cache misses the number of optimized traces generated would be limited.

A variety of optimization techniques may be used to dynamically modify program code. For example, pre-execution is a well-known latency tolerance technique. An example of the pre-execution technique is the use of the prefetch instruction. In data cache prefetching, instructions that prefetch the cache line for the data are inserted sufficiently prior to the actual reference of the data, thereby hiding the cache miss latency. Instructions, however, may not include the entire program up to that point. Otherwise, pre-execution is tantamount to normal execution and no latency hiding may be achieved.

The address computation on what data item to prefetch is only an approximation. Since data cache prefetch instructions are merely hints to the processor, generally they will not affect the correct execution of the program. Prefetch and its address computation instructions can be scheduled speculatively to overcome common data and control dependencies. Therefore, prefetch can often be initiated earlier to hide a large fraction of the miss latency. Since the address computing instructions for prefetch may be scheduled speculatively, the instructions may need to use non-faulting versions to avoid possible exceptions.

Since many important data cache misses often occur in loops, the optimization 130 phase pays particular attention to inserting prefetches in loops. The general prefetch insertion scheme, which is well known, may not typically work very well for loops. This is because the generated prefetch code sequence needs to be scheduled across the backward branch to the previous iteration, which is the same loop body as the current iteration. So there are many register and address computation adjustments to be made. This type of scheduling becomes rather difficult and complex to perform for the executable program code 150, which is typically in a binary code format.

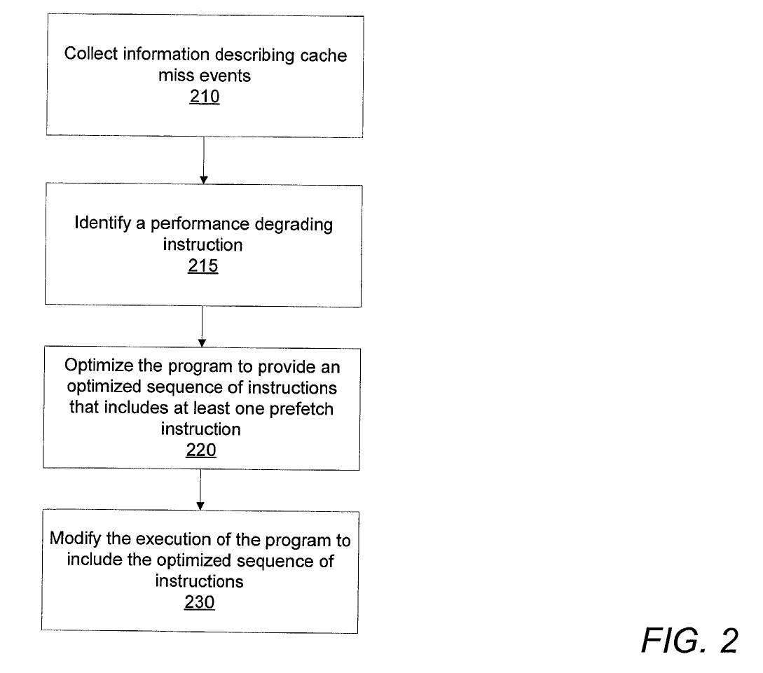

FIGS. 2, 3 and 4 illustrate various embodiments of a method for optimizing a program being executed. Referring to FIG. 2, in one embodiment, a flowchart to optimize instructions included in a program being executed is illustrated. In step 210, information describing program performance degrading events such as the occurrences of a plurality of data cache misses is collected. At least one instruction, e.g., a performance degrading instruction, causes the plurality of cache misses. The frequency of occurrence of each data cache miss attributable to the at least one instruction is included in the information collected. Execution of additional instructions may also contribute to the plurality of cache misses. The frequency of occurrence of each data cache miss attributable to each of the additional instructions may be included in the information collected. In step 215, a performance degrading instruction included in a sequence of instructions contributing to the highest occurrence of cache misses is identified. In one embodiment, the most cache misses may be caused by L2/L3 data cache misses. In another embodiment, a performance degrading instruction causing cache misses and resulting in the greatest performance penalty is identified. Although, the number of cache misses often determines the level of degradation in the performance of the program, in some cases multiple cache misses may be overlapped. In this case, the performance penalty of several cache misses may have the same impact as a single cache miss. In step 220, the sequence of instructions that caused the most data cache misses is optimized by providing an optimized sequence of instructions. A sequence of instructions that caused the performance degrading event such as the occurrence of the plurality of data cache misses includes the execution of the performance degrading instruction. The optimized sequence of instructions includes at least one prefetch instruction. The prefetch instruction is preferably inserted in the optimized sequence of instructions sufficiently prior to the performance degrading instruction. In one embodiment, optimizing the sequence of instructions includes determining whether each of the plurality of the data cache misses is a significant event, e.g., an L2/L3 data cache miss. In another embodiment, the optimized sequence is provided while the program is placed in a suspend mode of operation. In yet another embodiment, the optimized sequence may be provided while the program is being executed. In step 230, the executable program code 150 of the program being executed is modified to include the optimized sequence. In one embodiment, the modification includes placing the program in an execute mode from the suspend mode of operation.

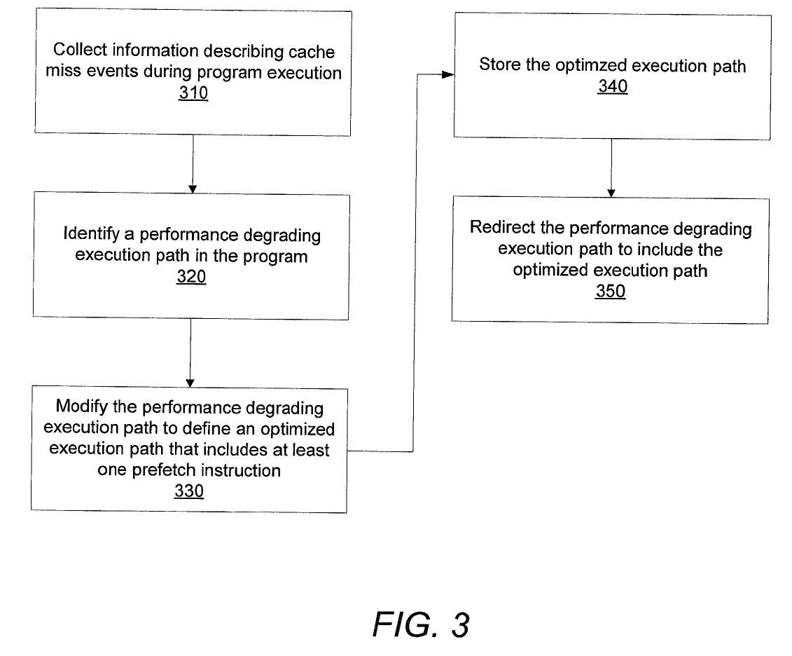

Referring to FIG. 3, in another embodiment, a flowchart to optimize instructions included in a program being executed is illustrated. In step 310, information describing a plurality of occurrences of a program performance degrading events such as a plurality of data cache misses is collected while the program is being executed, e.g., during a runtime mode of the program. The data cache misses may be attributable to at least one instruction. In one embodiment, additional instructions may also contribute to the occurrences of data cache miss events. In one embodiment, step 310 is substantially similar to program performance monitoring 110 phase of FIG. 1. In step 320, a performance degrading execution path in the program is identified. As described earlier, the program is typically capable of traversing a plurality of execution paths from start to finish. Each of the plurality of execution paths typically includes a sequence of instructions. The number of execution paths may vary depending on the application. Based on the information gathered in step 310, a particular execution path may be identified to contribute substantially to a degraded program performance, e.g., by contributing to highest number of occurrences of data cache misses. The particular execution path is identified as the performance degrading execution path. The performance degrading execution path includes at least one performance degrading instruction that contributes substantially to the degraded program performance. In step 330, the performance degrading execution path is modified to define an optimized execution path. In one embodiment, the optimized execution path includes at least one prefetch instruction. In step 340, the one or more instructions included in the optimized execution path are stored in memory, e.g., code cache 140. In step 350, the performance degrading execution path is redirected to include the optimized execution path. Thus, the at least one prefetch instruction is executed sufficiently prior to the execution of performance degrading instruction to reduce latency.

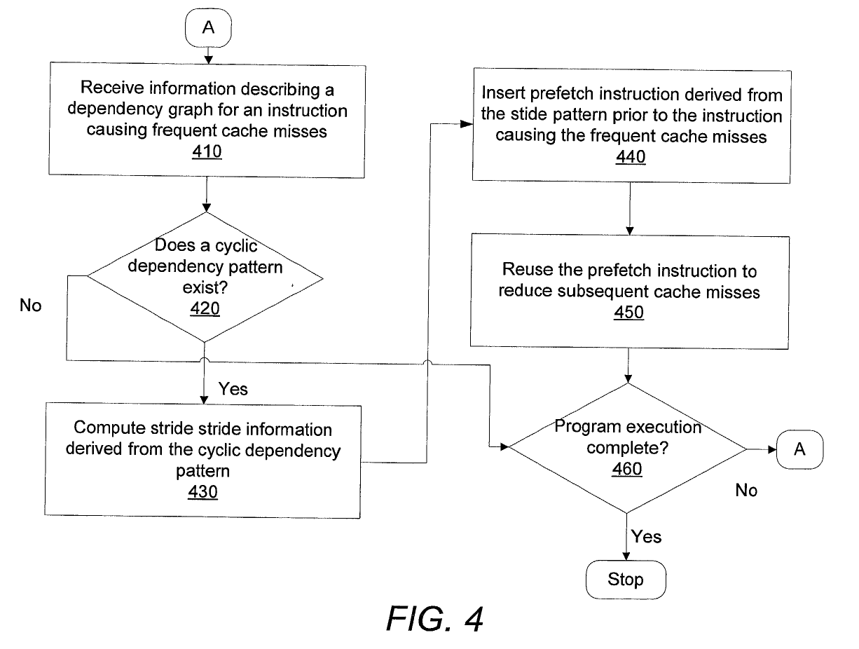

Referring to FIG. 4, in another embodiment, a flowchart to optimize instructions included in a program being executed is illustrated. In this embodiment, a backward slice analysis technique is used to check for the possibility of a presence of a pattern associated with performance degrading instructions. The backward slice, as referred to herein, may be described as a subset of the program code that relates to a particular instruction, e.g., a performance degrading instruction. The backward slice of a program degrading instruction typically includes all instructions in the program that contribute, either directly or indirectly, to the computation of the program degrading instruction.

In step 410, information describing a dependency graph for an instruction included in the program, and causing frequent cache misses is received. The dependency graph of a backward slice describes the dependency relationship between the instruction causing frequent cache misses and other instructions contributing to program performance degrade. If there are multiple memory operations with frequent data cache misses in the trace, a combined dependency graph is prepared.

In step 420 it is determined whether a cyclic dependency pattern exists in the dependency graph. If the trace is a loop or a part of a loop, e.g., when trace includes a backward branch to the beginning of the trace, there is a possibility of the existence of cyclic dependencies in the graph. The optimization method may handle non-constant cyclic patterns. If no cyclic dependency pattern exists then normal program execution may continue till completion.

In step 430, if the cyclic dependency pattern exists then, stride information is derived from the cyclic dependency pattern. A stride, as used herein, typically refers to a period or an interval of the cyclic dependency pattern. For example, in a sequence of memory reads and writes to addresses, each of which is separated from the last by a constant interval, the constant interval is referred to as the stride length, or simply as the stride. Cycles in dependency graph are recorded and processed to identify stride information.

In step 440, a prefetch instruction derived from the stride information is inserted in the program execution code to optimize the program, e.g., by reducing latency. In one embodiment, the dynamic optimizer may generate a “pre-load” and a “prefetch” instruction with strides derived from the dependency cycle to fetch and compute prefetch address for the next or subsequent iteration of the loop. The inserted prefetch instruction is included to define a new optimized code. The new optimized code, including the prefetch instruction, is inserted into the executable program binary code sufficiently prior to the instruction causing the frequent cache misses. In step 450, the new optimized code, including the prefetch instruction, in the program is reused for reducing subsequent cache misses. In step 460, it is determined whether program execution is complete. If it is determined that the program execution is not complete then steps 410 through 450 are performed dynamically, e.g., during runtime of the program. In one embodiment, steps 410, 420, 430 and 440 may be advantageously used to optimize step 220 of FIG. 2, and step 330 of FIG. 3.

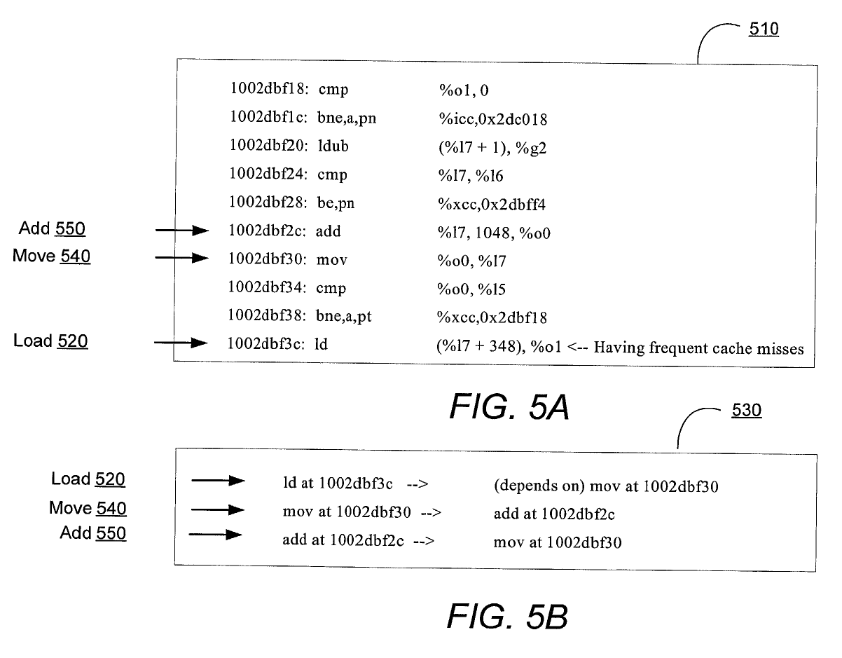

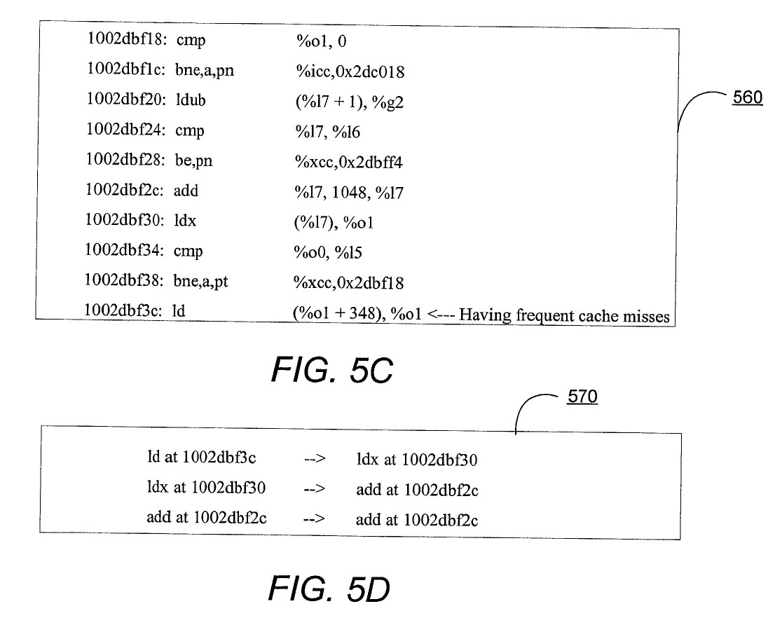

FIGS. 5A-5D illustrate two examples of program code that may be optimized at runtime. Referring to FIG. 5A, program code illustrates an example 510 of optimizing a trace using the prefetch instruction during the optimization 130 phase and is described below. In the trace selection 120 phase, the example 510 trace is selected, where the load 520 instruction located at 1002dbf3c has been identified to have frequent data cache misses, using information and sampled data cache miss events collected in performance monitoring 110 phase.

In one embodiment, the backward slice technique is used in order to optimize the code included in example 510. The code optimization may be performed by using the prefetch instruction. A backward slice from the performance degrading instruction, e.g., load 520 instruction located at 1002dbf3c is obtained by following the data dependent instructions backward in the trace.

Referring to FIG. 5B, the data dependence chain 530 for example 510 is shown. Here, A→B implies instruction A depends on instruction B.

Since the trace of FIG. 5A is a loop, the dependence relationship between move 540 instruction at location 1002dbf30 and add 550 instruction at location 1002dbf2c forms a cycle, and it may be derived that the register 17 is to be incremented by 1048. Therefore, the reference made by the load 520 instruction at location 1002dbf3c has a regular stride of 1048. The dynamic optimizer 100 may decide to insert a prefetch instruction sufficiently prior to the load 520 instruction that causes the frequent cache misses. For example, in one embodiment, the prefetch instruction may be inserted one or two iterations ahead of the reference instruction, e.g., load 520, such as:

| | |
|---|---|
| PREFETCH | (%17 + 1388) for the next iteration or |
| PREFETCH | (%17 + 2436) for two iterations ahead of the reference. |

Referring to FIG. 5C, program code illustrates another example 560 of optimizing a trace using the prefetch instruction during the optimization 130 phase and is described below. Example 560 trace shows an indirect reference pattern.

Referring to FIG. 5D, the backward slice shows the dependence chain 570 for example 560. Since the address computing instructions for prefetch may be scheduled speculatively, it would be preferable to use non-faulting versions to avoid possible exceptions. The “1dxa” instruction is a non-faulting version of a “1dx” instruction. To optimize the code, the dynamic optimizer 100 may decide to insert a prefetch instruction such as:

| | |
|---|---|
| ldxa | (%17 + 1048), %11 |
| PREFETCH | (%11 + 348). |

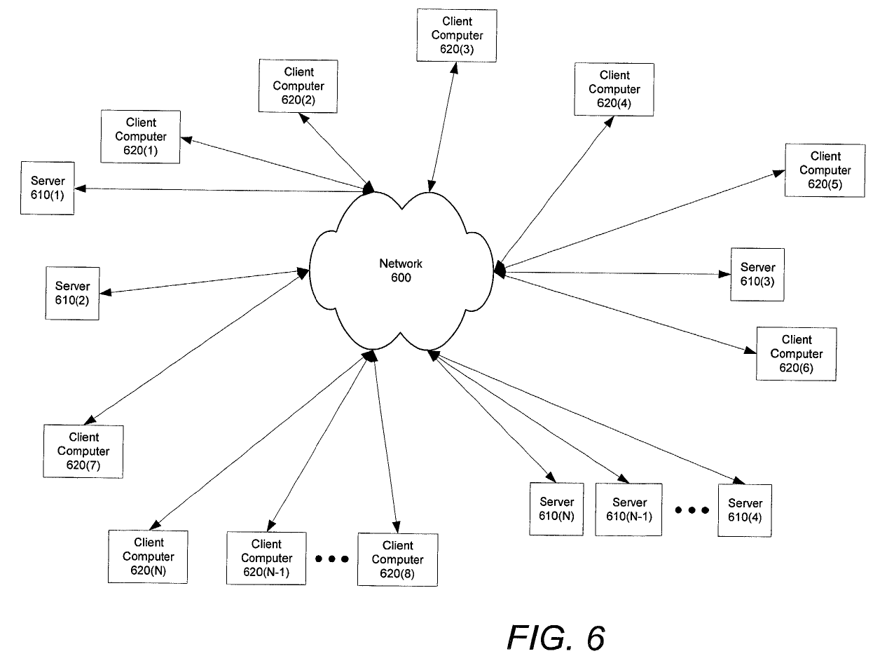

Referring to FIG. 6, a block diagram illustrating a network environment in which a system according to one embodiment of the present invention may be practiced is shown. As is illustrated in FIG. 6, network 600, such as a private wide area network (WAN) or the Internet, includes a number of networked servers 610(1)-(N) that are accessible by client computers 620(1)-(N). Communication between client computers 620(1)-(N) and servers 610(1)-(N) typically occurs over a publicly accessible network, such as a public switched telephone network (PSTN), a DSL connection, a cable modem connection or large bandwidth trunks (e.g., communications channels providing T1 or OC3 service). Client computers 620(1)-(N) access servers 610(1)-(N) through, for example, a service provider. This might be, for example, an Internet Service Provider (ISP) such as America On-Line™, Prodigy™ CompuServe™ or the like. Access is typically had by executing application specific software (e.g., network connection software and a browser) on the given one of client computers 620(1)-(N).

One or more of client computers 620(1)-(N) and/or one or more of servers 610(l)-(N) may be, for example, a computer system of any appropriate design, in general, including a mainframe, a mini-computer or a personal computer system. Such a computer system typically includes a system unit having a system processor and associated volatile and non-volatile memory, one or more display monitors and keyboards, one or more diskette drives, one or more fixed disk storage devices and one or more printers. These computer systems are typically information handling systems which are designed to provide computing power to one or more users, either locally or remotely. Such a computer system may also include one or a plurality of I/O devices (i.e., peripheral devices) which are coupled to the system processor and which perform specialized functions. Examples of I/O devices include modems, sound and video devices and specialized communication devices. Mass storage devices such as hard disks, CD-ROM drives and magneto-optical drives may also be provided, either as an integrated or peripheral device. One such example computer system, discussed in terms of client computers 620(1)-(N) is shown in detail in FIG. 6.

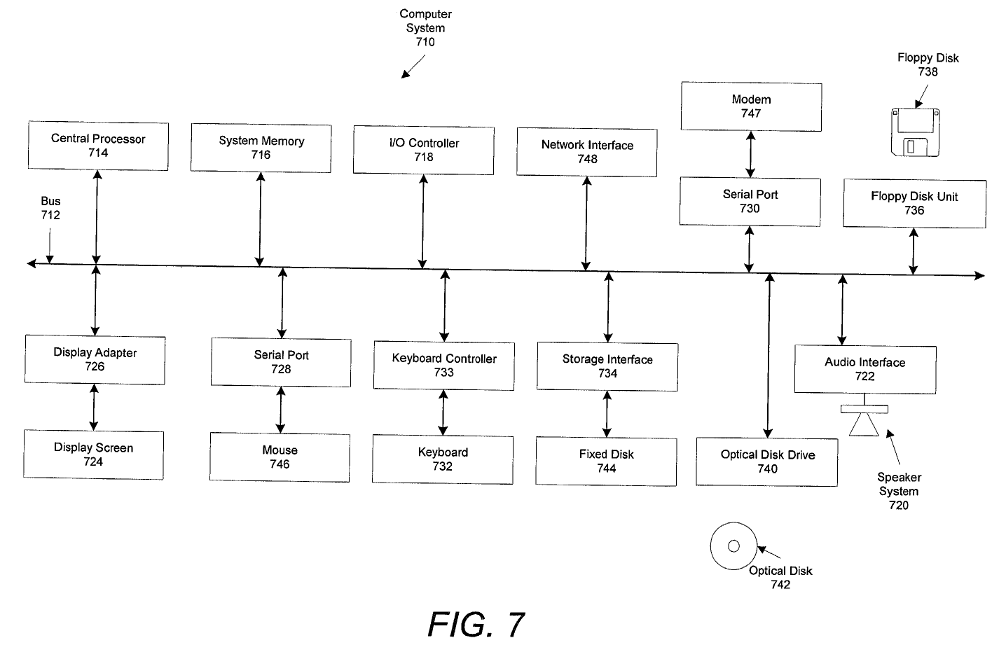

FIG. 7 depicts a block diagram of a computer system 710 suitable for implementing an embodiment of the present invention, and example of one or more of client computers 620(1)-(N). Computer system 710 includes a bus 712 which interconnects major subsystems of computer system 710 such as a central processor 714, a system memory 716 (typically RAM, but which may also include ROM, flash RAM, or the like), an input/output controller 718, an external audio device such as a speaker system 720 via an audio output interface 722, an external device such as a display screen 724 via display adapter 726, serial ports 728 and 730, a keyboard 732 (interfaced with a keyboard controller 733), a storage interface 734, a floppy disk drive 736 operative to receive a floppy disk 738, and an optical disc drive 740 operative to receive an optical disk 742. Also included are a mouse 746 (or other point-and-click device, coupled to bus 712 via serial port 728), a modem 747 (coupled to bus 712 via serial port 730) and a network interface 748 (coupled directly to bus 712).

Bus 712 allows data communication between central processor 714 and system memory 716, which may include both read only memory (ROM) or flash memory (neither shown), and random access memory (RAM) (not shown), as previously noted. The RAM is generally the main memory into which the operating system and application programs are loaded and typically affords at least 64 megabytes of memory space. The ROM or flash memory may contain, among other code, the Basic Input-Output system (BIOS) which controls basic hardware operation such as the interaction with peripheral components. Applications resident with computer system 710 are generally stored on and accessed via a computer readable medium, such as a hard disk drive (e.g., fixed disk 744), an optical disk drive 740 (e.g., CD-ROM or DVD drive), floppy disk unit 736 or other storage medium. Additionally, applications may be in the form of electronic signals modulated in accordance with the application and data communication technology when accessed via network modem 747 or interface 748.

Storage interface 734, as with the other storage interfaces of computer system 710, may connect to a standard computer readable medium for storage and/or retrieval of information, such as a fixed disk drive 744. Fixed disk drive 744 may be a part of computer system 710 or may be separate and accessed through other interface systems. Many other devices can be connected such as a mouse 746 connected to bus 712 via serial port 728, a modem 747 connected to bus 712 via serial port 730 and a network interface 748 connected directly to bus 712. Modem 747 may provide a direct connection to a remote server via a telephone link or to the Internet via an Internet service provider (ISP). Network interface 748 may provide a direct connection to a remote server via a direct network link to the Internet via a POP (point of presence). Network interface 748 may provide such connection using wireless techniques, including digital cellular telephone connection, Cellular Digital Packet Data (CDPD) connection, digital satellite data connection or the like.

Many other devices or subsystems (not shown) may be connected in a similar manner (e.g., bar code readers, document scanners, digital cameras and so on). Conversely, it is not necessary for all of the devices shown in FIG. 7 to be present to practice various embodiments described in the present invention. The devices and subsystems may be interconnected in different ways from that shown in FIG. 7. In a simple form, a computer system 710 may include processor 714 and memory 716. Processor 714 is typically enabled to execute instructions stored in memory 716. The executed instructions typically perform a function. Information handling systems may vary in size, shape, performance, functionality and price. Examples of computer system 710, which include processor 714 and memory 716, may include all types of computing devices within the range from a pager to a mainframe computer.

The operation of a computer system such as that shown in FIG. 7 is readily known in the art and is not discussed in detail in this application. Code to implement the various embodiments described in the present invention may be stored in computer-readable storage media such as one or more of system memory 716, fixed disk 744, optical disk 742, or floppy disk 738. Additionally, computer system 710 may be any kind of computing device, and so includes personal data assistants (PDAs), network appliance, X-window terminal or other such computing device. The operating system provided on computer system 710 may be MS-DOS®, MS-WINDOWS®, OH/2®, UNIX®, Linux® or other known operating system. Computer system 710 also supports a number of Internet access tools, including, for example, an HTTP-compliant web browser having a JavaScript interpreter, such as Netscape Navigator®, Microsoft Explorer® and the like.

Moreover, regarding the signals described herein, those skilled in the art will recognize that a signal may be directly transmitted from a first block to a second block, or a signal may be modified (e.g., amplified, attenuated, delayed, latched, buffered, inverted, filtered or otherwise modified) between the blocks. Although the signals of the above described embodiment are characterized as transmitted from one block to the next, other embodiments of the present invention may include modified signals in place of such directly transmitted signals as long as the informational and/or functional aspect of the signal is transmitted between blocks. To some extent, a signal input at a second block may be conceptualized as a second signal derived from a first signal output from a first block due to physical limitations of the circuitry involved (e.g., there will inevitably be some attenuation and delay). Therefore, as used herein, a second signal derived from a first signal includes the first signal or any modifications to the first signal, whether due to circuit limitations or due to passage through other circuit elements which do not change the informational and/or final functional aspect of the first signal.

The foregoing described embodiment wherein the different components are contained within different other components (e.g., the various elements shown as components of computer system 710). It is to be understood that such depicted architectures are merely examples, and that in fact many other architectures can be implemented which achieve the same functionality. In an abstract, but still definite sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermediate components. Likewise, any two components so associated can also be viewed as being “operably connected”, or “operably coupled”, to each other to achieve the desired functionality.

In one embodiment, the computer system 710 includes a computer-readable medium having a computer program or computer system 710 software accessible therefrom, the computer program including instructions for performing the method of dynamic optimization of a program being executed. The computer-readable medium may typically include any of the following: a magnetic storage medium, including disk and tape storage medium; an optical storage medium, including optical disks 742 such as CD-ROM, CD-RW, and DVD; a non-volatile memory storage medium; a volatile memory storage medium; and data transmission or communications medium including packets of electronic data, and electromagnetic or fiber optic waves modulated in accordance with the instructions.

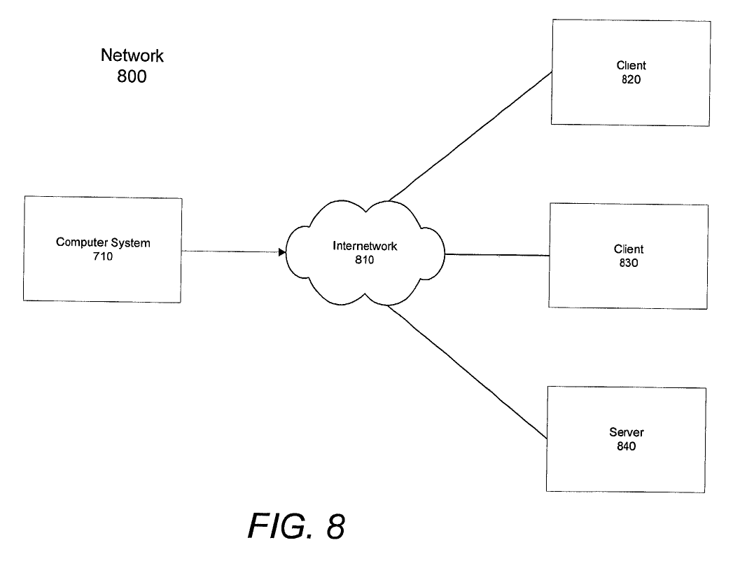

FIG. 8 is a block diagram depicting a network 800 in which computer system 710 is coupled to an internetwork 810, which is coupled, in turn, to client systems 820 and 830, as well as a server 840. Internetwork 810 (e.g., the Internet) is also capable of coupling client systems 820 and 830, and server 840 to one another. With reference to computer system 810, modem 847, network interface 848 or some other method can be used to provide connectivity from computer system 810 to internetwork 810. Computer system 810, client system 820 and client system 830 are able to access information on server 840 using, for example, a web browser (not shown). Such a web browser allows computer system 810, as well as client systems 820 and 830, to access data on server 840 representing the pages of a website hosted on server 840. Protocols for exchanging data via the Internet are well known to those skilled in the art. Although FIG. 8 depicts the use of the Internet for exchanging data, the present invention is not limited to the Internet or any particular network-based environment.

Referring to FIGS. 6, 7 and 8, a browser running on computer system 810 employs a TCP/IP connection to pass a request to server 840, which can run an HTTP “service” (e.g., under the WINDOWS® operating system) or a “daemon” (e.g., under the UNIX® operating system), for example. Such a request can be processed, for example, by contacting an HTTP server employing a protocol that can be used to communicate between the HTTP server and the client computer. The HTTP server then responds to the protocol, typically by sending a “web page” formatted as an HTML file. The browser interprets the HTML file and may form a visual representation of the same using local resources (e.g., fonts and colors).

Although the present invention has been described in connection with several embodiments, the invention is not intended to be limited to the specific forms set forth herein, but on the contrary, it is intended to cover such alternatives, modifications, and equivalents as can be reasonably included within the scope of the invention as defined by the appended claims.

What is claimed is:

1. A method of optimizing instructions included in a program being executed, the method comprising:
collecting information describing a frequency of occurrence of a plurality of cache misses caused by at least one instruction;
identifying a performance degrading instruction;
optimizing the program to provide an optimized sequence of instructions, the optimized sequence of instructions comprising at least one prefetch instruction; and
modifying the program being executed to include the optimized sequence.

2. The method of claim 1, wherein the program comprises a plurality of sequence of instructions.

3. The method of claim 1, wherein the performance degrading instruction contributes to highest frequency of occurrence of the plurality cache misses.

4. The method of claim 1, wherein the performance degrading instruction contributes to highest degradation in the program performance.

5. The method of claim 1, wherein the at least one instruction is the performance degrading instruction.

6. The method of claim 1, wherein optimizing the program comprises inserting the at least one prefetch instruction prior to the performance degrading instruction.

7. The method of claim 1, wherein the plurality cache misses are L2/L3 cache misses.

8. The method of claim 1, wherein the optimized sequence is prepared while the program is placed in a suspend mode.

9. The method of claim 8, wherein modifying the program comprises:
changing the program from the suspend mode to the execution mode.

10. The method of claim 1, wherein optimizing the program comprises:
receiving information describing a dependency graph for the at least one instruction;
determining whether a cyclic dependency pattern exists in the dependency graph;
if the cyclic dependency pattern exists then, computing stride information derived from the cyclic dependency pattern; and
inserting the prefetch instruction derived from the stride information, the prefetch instruction being inserted into the program prior to the performance degrading instruction.

11. The method of claim 10, wherein the dependency graph is a backward slice from the performance degrading instruction.

12. The method of claim 1, wherein modifying the program comprises:
storing the optimized sequence;
redirecting a sequence of instructions having the performance degrading instruction to include the optimized sequence.

13. A method of optimizing a program comprising a plurality of execution paths, the method comprising:
collecting information describing a plurality of occurrences of a plurality of cache miss events during a runtime mode of the program;
identifying a performance degrading execution path in the program;
modifying the performance degrading execution path to define an optimized execution path, the optimized execution path comprising at least one prefetch instruction;
storing the optimized execution path; and
redirecting the performance degrading execution path in the program to include the optimized execution path.

14. The method of claim 13, wherein the plurality of cache miss events are caused by an execution of a plurality of performance degrading instructions.

15. The method of claim 13, wherein identifying the performance degrading path comprises identifying a performance degrading instruction contributing to highest plurality of occurrences of cache miss events.

16. The method of claim 13, wherein the optimized execution path is defined while placing the program in a suspend mode from the runtime mode.

17. The method of claim 16, wherein the optimized execution path is executed on resuming the runtime mode of the program code from the suspend mode.

18. The method of claim 16, wherein redirecting the performance degrading execution path comprises:
changing the program mode from the suspend mode to the execution mode.

19. The method of claim 13, wherein the performance degrading execution path comprises a performance degrading instruction causing the cache miss event.

20. The method of claim 19, wherein the at least one prefetch instruction is inserted prior to the performance degrading instruction.

21. The method of claim 13, wherein identifying the performance degrading execution path comprises determining whether a cache miss event of the plurality of cache miss events is an L2/L3 cache miss.

22. The method of claim 13, wherein identifying the performance degrading path comprises identifying a performance degrading instruction contributing to highest degradation in the program performance.

23. The method of claim 13, wherein modifying the performance degrading execution path comprises:
receiving information describing a dependency graph for a program degrading instruction contributing to highest occurrence of the plurality of cache miss events, the performance degrading instruction being included in the performance degrading execution path;
determining whether a cyclic dependency pattern exists in the graph;
if the cyclic dependency pattern exists then, computing stride information derived from the cyclic dependency pattern; and
inserting the at least one prefetch instruction derived from the stride information, the at least one prefetch instruction being inserted into the optimized execution path prior to the performance degrading instruction.

24. The method of claim 23, wherein the dependency graph is a backward slice from the performance degrading instruction.

25. A method of optimizing a program, the method comprising:
receiving information describing a dependency graph for an instruction causing frequent cache misses, the instruction being included in the program;
determining whether a cyclic dependency pattern exists in the graph;
if the cyclic dependency pattern exists then, computing stride information derived from the cyclic dependency pattern;
inserting an at least one prefetch instruction derived from the stride information, the at least one prefetch instruction being inserted into the program prior to the instruction causing the frequent cache misses;
reusing the at least one prefetch instruction in the program for reducing subsequent cache misses; and
performing said receiving, said determining, said computing, said inserting and said reusing during runtime of the program.

26. A computer-readable medium having a computer program accessible therefrom, wherein the computer program comprises instructions for:
collecting information describing a frequency of occurrence of a plurality of cache misses caused by at least one instruction;
identifying a performance degrading instruction;
optimizing the computer program to provide an optimized sequence of instructions, the optimized sequence of instructions comprising at least one prefetch instruction; and
modifying the computer program being executed to include the optimized sequence.

27. A computer system comprising:
a processor;
a memory coupled to the processor;
a program comprising instructions, the program being stored in memory, the processor executing instructions to:
collect information describing a frequency of occurrence of a plurality of cache misses caused by at least one instruction;
identify a performance degrading instruction;
optimize the program to provide an optimized sequence of instructions, the optimized sequence of instructions comprising at least one prefetch instruction; and
modify the program being executed to include the optimized sequence.
